(19) United States
(12) Patent Application Publication
(10) Pub. No.: US 2024/0272894 A1
(43) Pub. Date: Aug. 15, 2024

(54) REMOTE UPDATE OF SOFTWARE ON A WORK VEHICLE

(71) Applicant: Caterpillar lnc., Peoria, IL (US)

(72) Inventors: Christopher J. GREEN, Cambridgeshire (GB); Adam STUBBS, Lincolnshire (GB)

(73) Assignee: Caterpillar lnc., Peoria, IL (US)

(21) Appl. No.: 18/563,523

(22) PCT Filed: May 10, 2022
(86) PCT No.: PCT/US2022/028453

§ 371 Date: Nov. 22, 2023

(30) Foreign Application Priority Data
May 27, 2021 (GB) 2107587.4

(51) Int. Cl. G06F 8/65; B60L 58/10

(52) U.S. Cl. CPC G06F 8/65; B60L 58/10

(57) ABSTRACT

Remote updating of software on a target module of an electric work vehicle including a rechargeable battery. When a software update for the machine's software is available a determination is made as to whether or not the machine's rechargeable battery is connected to a charging module. If the machine's rechargeable battery is connected to a charging module, the software update is provided on the target module. If the machine's rechargeable battery is not connected to a charging module, the software update is delayed until the rechargeable battery is connected to a charging module. The software update to the target module may be performed via remote flashing.

### FIELD

The disclosure relates to the field of electric work vehicles.

### BACKGROUND

It is known that electric work vehicles or construction machines rely on batteries that are charged by an AC supply or a DC charging station. The health of such batteries slowly degrades over time, and the decision of when to replace the batteries should strike a balance between maintaining performance and reducing waste.

Electric work vehicles feature software stored in on board modules, for example to control and manage components of the work vehicles. The software is typically a flash file, stored on a memory device. Battery management software may be used to collect data relating to the health of the battery. The data relating to the health of the battery may be used on-board to calculate the current capacity of the battery, and may be transmitted to an external location to be used in predicting the health and expected capacity of the battery over time. Knowledge of the current capacity of the battery and its expected capacity over time may be useful when determining the both how the work vehicle should be used and when the battery should be replaced.

Conventionally, a technician is required to visit the machine to update the software to ensure that the update is carried out in a safe manner and without interrupting the operation or maintenance of the machine. The update requires dedicating both the technician's time and a period of down time of the work vehicle. To avoid the need for a technician, conventional work vehicles have begun to incorporate remote software distribution capabilities whereby software is updated through an Internet provider, based on commands received from a user of the work vehicle. Other systems send any new update wirelessly to the work vehicle based on the availability of the update, rather than input from a user of the work vehicle or the status of the work vehicle.

### SUMMARY

Against this background, there is provided a method of remotely updating software on a target module of an electric work vehicle comprising a rechargeable battery. The method comprises determining that a software update exists for the software. The method further comprises determining whether the rechargeable battery is connected to a charging module. In an event that the rechargeable battery is connected to a charging module the method proceeds to the next step. In an event that the rechargeable battery is not connected to a charging module, the next step is delayed until the rechargeable battery is connected to a charging module. The method further comprises updating the software via remote flashing. The method may further comprise notifying a user of the electric work vehicle that the software will be updated.

In this way, it may be possible to update the software of the electric work vehicle in a manner that avoids interrupting the work of the electric work vehicle and where there can be confidence that the electric work vehicle is already in a low risk state and environment by virtue of it being connected to the charging module. While connected to the charging module, both movement and implement operation of an electric vehicle are prevented. It may also be assumed that the electric work vehicle is in a low risk environment while connected to the charging module, away from risks of a worksite.

### BRIEF DESCRIPTION OF THE DRAWINGS

A specific embodiment of the disclosure will now be described, by way of example only, with reference to the accompanying drawings in which:

FIG. 1 shows a flowchart illustrating a method of remotely updating software on an electric work vehicle in accordance with an embodiment of the disclosure.

FIG. 2 shows a flowchart illustrating a method of remotely updating software on an electric work vehicle, with an additional step of downloading the update, in accordance with an embodiment of the disclosure.

FIG. 3 shows a flowchart illustrating a method of remotely updating software on an electric work vehicle, with an additional step of notifying the user, in accordance with an embodiment of the disclosure.

FIG. 4 shows a flowchart illustrating a method of remotely updating software on an electric work vehicle, with an additional step of notifying the user, in accordance with an embodiment of the disclosure.

FIG. 5 shows a flowchart illustrating a method of remotely updating software on an electric work vehicle, with an additional step of notifying the user that the installation is complete, in accordance with an embodiment of the disclosure.

FIG. 6 shows a schematic diagram of a target module with software to be updated, connected to components within an electric work vehicle and a charging module in accordance with an embodiment of the disclosure.

### DETAILED DESCRIPTION

According to an embodiment of this disclosure, there is a method of remotely updating software on a target module of an electric work vehicle comprising a rechargeable battery.

A method of remotely updating software on a target module of an electric work vehicle comprises a step of determining that a software update exists for the software. The method also comprises a step of determining whether the rechargeable battery is connected to a charging module. In an event that the rechargeable battery is not connected to a charging module, the next step of the method is delayed until the rechargeable battery is connected to a charging module the method proceeds to the next step. Once the rechargeable battery is connected to a charging module, a user of the electric work vehicle is notified that the software will be updated. The software is updated via remote flashing.

Updating the software while the rechargeable battery is connected means that it is possible to update the software of the electric work vehicle in a manner that avoids interrupting the work of the electric work vehicle and where there can be confidence that the electric work vehicle is already in a low risk state and environment by virtue of it being connected to the charging module. While connected to the charging module, both movement and implement operation of an electric vehicle are prevented. It may also be assumed that the electric work vehicle is in a low risk environment while connected to the charging module, away from risks of a worksite.

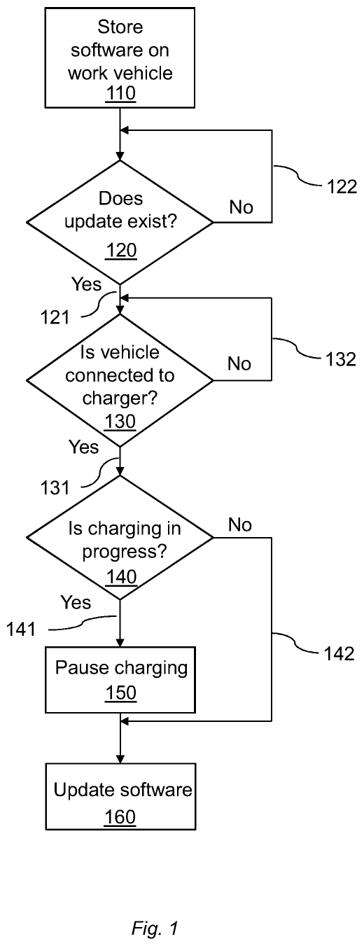

With reference to FIG. 1, a method according to a first embodiment of the disclosure is illustrated by a flowchart. Battery management system (BMS) software is stored locally on the electric work vehicle, indicated at step 110, and is configured to collect data for monitoring the health of the battery. At step 120, it is determined whether an update exists for the software. If there is no update available (option “no” 122 on the flowchart), the method pauses in loop 122 until an update exists. If there is an update available (option “yes” 121 on the flowchart), it is determined at step 130 whether the vehicle is connected to a charging module. The charging module may comprise a single phase alternating current (AC) supply, a three phase AC supply, a direct current (DC) fast charging station or other charging apparatus. In the event that the vehicle is not connected to a charging module (option “no” 132 on the flowchart), the method pauses in loop 132 until the vehicle is connected to a charging module. In the event that the vehicle is connected to a charging module (option “yes” 131 on the flowchart), step 140 determines whether charging of the battery is in progress. In the event that charging is in progress, the charging is paused (option “yes” 141 leading to step 150). If the vehicle is connected to the charging module but is not currently being charged (option “no” 142), the method proceeds to step 160. At step 160, the software update is installed. The installation of the update may comprise a flashing process, whereby the software is overwritten by the updated software. During step 160, charging of the battery may cease and the battery may be prevented from being disconnected from the charging module.

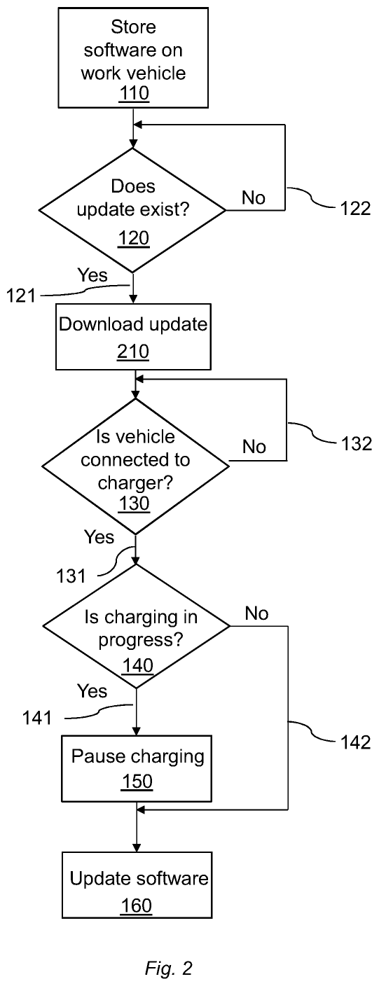

The step 120 of determining whether an update exists for the software may be carried out at a location removed from the electric work vehicle, for example by a person overseeing one or more electric vehicles. That person may authorise the wireless download of the software update onto the electric vehicle. The step 120 for determining whether an update exists for the software may otherwise or additionally be carried out by the electric work vehicle. If the electric work vehicle is turned off for long periods of time, the electric work vehicle may be configured to turn on at periodic intervals and check whether an update exists. With reference to FIG. 2, the download of the update may occur at step 210, after step 120 that determines whether the update exists.

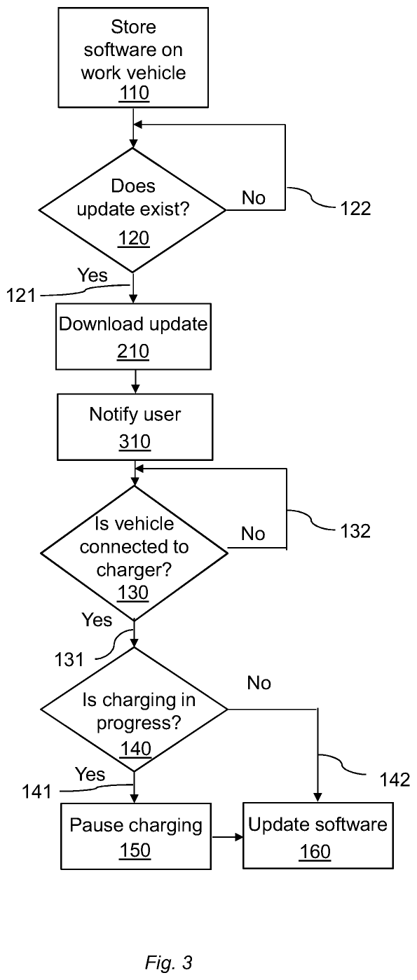

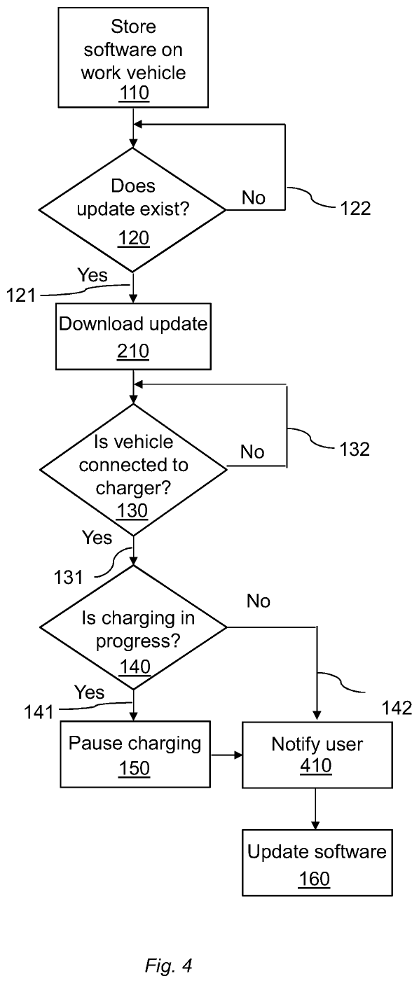

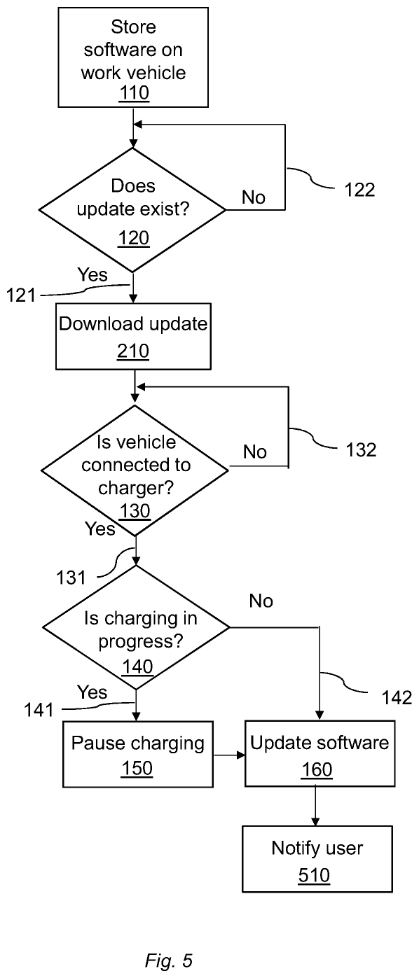

With reference to FIGS. 3 to 5, a local user of the electric vehicle may be notified that the software is due to be updated. In an embodiment, the local user may be notified at step 310, after the update has been downloaded. The local user may be required to authorize the installation of the software before the method proceeds to step 130. In another embodiment, the local user may be notified at step 410 after it has been determined that the electric vehicle is connected to a charging module and that the installation is safe to proceed. The local user may be notified at step 510 that the installation is complete, after step 160. The notifications may comprise a text message or electronic message that may be accessed on a device external to the electric work vehicle, or the notification may be displayed on a screen, or otherwise, on the electric work vehicle.

Step 130 of determining whether the electric work vehicle is connected to a charger may comprise determining whether there is a live charging cable connection. This may be confirmed to the BMS via Controller Area Network (CAN) messages for charging.

FIG. 6 shows a simplified exemplary schematic of a target module comprising a battery pack 610 that may undergo a remote software update in accordance with an embodiment of this disclosure, and its connections within an electric work vehicle 600. This is an exemplary arrangement, and the remote software update may be applied to target modules in alternative arrangements. The battery pack 610 may comprise a power storage module 611, a BMS 612 and a DC:DC converter 613. The BMS 612 may be connected to a CAN 620. The power storage module 611 may be connected via the DC:DC converter 613 to a machine switch 630, which may be connected to a machine controller 640 and a telematics module 650. There may be CAN connections to the machine controller 640 and the telematics module 650.

FIG. 6 shows the electric work vehicle 600 in the context of an external charging module 660 and a remote module 680. The external charging module 660 may comprise an AC supply (either single or three phase) or a DC charging station, and may be connected or disconnected to the electric work vehicle 600 via charging contactors 661. The charging module 660 may be connected to the power storage module 611 of the battery pack 610 via a fuse 670. A main contactor 614 in the battery pack allows the battery pack to be connected or disconnected from circuits of the electric work vehicle. The power storage module 611 may be charged at a high voltage, and the DC:DC converter 614 may convert the high voltage to a lower voltage suitable for components of the electric work vehicle 600.

Only when the main contactor 614 is closed is it possible (a) to operate the electric work vehicle 600 and (b) to charge the power storage module 611 of the battery pack 610 using the external charging module 660. Thus, if the main contactor 614 is open, it can be inferred that the electric work vehicle is not in use and also that the battery pack 610 is not being charged by the external charging module 660.

Moreover, since an external charging module 660 is likely to be sited away from active areas of a work site, if the electric vehicle 600 is connected to the external charging module 660, it can be inferred that the electric vehicle 600 is also located in a position that is appropriately remote from active areas of a worksite.

Therefore, if the electric vehicle is connected to the external charging module 660 and the main contactor 614 is open, it can be inferred that the electric work vehicle 600 is in a condition suitable for installing the update.

The telematics module 680 may communicate wirelessly with a remote module 680 that may comprise a data repository and a battery health predictor. The telematics module 680 may send measurements taken by the BMS 612 and may receive software updates.

As described above, the charging module 660 may comprise an AC supply or a DC supply. The charging module 660 may comprise or be connected to a converter such that the charging module 660 is able to charge electric work vehicles that require charging types or charging at different voltages. For example, the converter may control the charging current to a value that the battery can accept the charging module 660 may comprise or be connected to an AC:DC converter, to allow DC charging of the power storage module 611 from an AC supply. The AC:DC converter may be on board the electric work vehicle. The charging module 660 or converter may receive this information from the BMS via the CAN 620.

When the charging module 660 is connected to the electric work vehicle, the machine is taken to be in a safe condition to accept the installation of the software update. Machine movement and implement operation are not possible, due to interlocks, and machine servicing is prevented when the charge cable is live. Restricting the installation of the software update to when the charging module is connected avoids a safety issue (by either unexpectedly turning on the electric work vehicle when it is stationary or by unexpectedly causing the electric work vehicle to halt when it is in use) and avoids interrupting work.

In use, the updates for the software may be available as a subscription service, such that local users of the electric vehicle are provided with the software updates remotely without the need to book a technician to manually update the software. The subscription provider may send the updates to the vehicles and notify the local users that the update is available, or that an update has been installed. In the event that electric work vehicles are turned off for a long period, the method of the present disclosure may further comprise a controller of the electric work vehicle turning the electric work vehicle on at periodic intervals in order to be able to receive updates.

The BMS may act as a measurement device. For example, the BMS may take measurements of charge, current, voltage and temperature. The BMS may calculate the capacity of the battery. The BMS may take regular data that may be sent to the remote module 680, wherein the remote module 680 may comprise a health predictor that uses the data to predict the health of the battery. The health predictor may comprise a digital twin of the battery pack 610. A digital twin is a virtual representation of a physical object or process that serves as an exact counterpart of the physical object or process. It spans the lifecycle of the physical thing and is updated from real-time date, so aids model simulation of the physical object or process.

The invention is not limited to the disclosed embodiments.

1. A method of remotely updating software on a target module of an electric work vehicle comprising a rechargeable battery, comprising:
(a) determining that a software update exists for the software;
(b) determining whether the rechargeable battery is connected to a charging module, wherein either:
in an event that the rechargeable battery is connected to a charging module the method proceeds to step (c); or
in an event that the rechargeable battery is not connected to a charging module, step (c) is delayed until the rechargeable battery is connected to a charging module; and
(c) updating the software via remote flashing.

2. The method of claim 1, wherein during step (c) the rechargeable battery is prevented from charging.

3. The method of claim 1, wherein step (b) further comprises determining whether the rechargeable battery is undergoing charging.

4. The method of claim 3 wherein in the event that the rechargeable battery is undergoing charging the charging is paused until step (c) is complete.

5. The method of claim 3, wherein in the event that the rechargeable battery is undergoing charging step (b) further comprises determining a charging speed, and wherein either:
in the event that the charging speed is above a threshold the method waits to proceed to step (c) until charging is completed; or
in the event that the charging speed is below the threshold, charging is paused and the method proceeds to step (c).

6. The method of claim 1, wherein step (a) further comprises checking whether a software update exists for the software at periodic intervals.

7. The method of claim 5, wherein the periodic interval is one day.

8. The method of claim 6, wherein in the event that the electric work vehicle is turned off, step (a) further comprises a controller turning on the electric work vehicle at periodic intervals to check whether a software update exists for the software.

9. The method of claim 1 further comprising, a step of downloading the software update.

10. The method of claim 1, further comprising, a step of notifying a user that the software will be updated.

11. The method of claim 9 further comprising, a step of authorisation of at least one of downloading the software update and updating the software.

12. The method of claim 1, further comprising a step of notifying a user that step (c) is complete.

13. The method of claim 8, wherein notifying the user comprises at least one of displaying a message on an on-board display screen, sending the user an electronic message and sending the user a text message.

14. The electric work vehicle comprising:
a rechargeable battery; and
a target module on which software is stored, wherein the software is remotely updated using the method of claim 1.

15. The method of claim 1 wherein rechargeable battery is prevented from disconnecting from the charging module during step (c).
